(19) United States
(12) Patent Application Publication
(10) Pub. No.: US 2010/0100205 A1
(43) Pub. Date: Apr. 22, 2010

(54) Device of Playing Music and Method of Outputting Music Thereof

(76) Inventor: Joong Gun Park, Seoul (KR)

Correspondence Address: THE WEBB LAW FIRM, P.C., 700 KOPPERS BUILDING, 436 SEVENTH AVENUE, PITTSBURGH, PA, 15219, US

(21) Appl. No.: 11/997,353

(22) PCT Filed: Oct. 13, 2006
(86) PCT No.: PCT/KR06/04146

§ 371 Date: Jan. 30, 2008

(30) Foreign Application Priority Data
Oct. 11, 2006 (KR) 10-2006-0099044

(51) Int. Cl. G06F 17/00

(52) U.S. Cl. 700/94

(57) ABSTRACT

Disclosed herein a device for playing music according to the present invention and a method of outputting sounds using the same. The device for playing music according to the present invention includes a rhythm bank unit including a plurality of rhythm banks, each of which stores a plurality of sound sources as a group, and a plurality of bank switches corresponding to the plurality of rhythm banks, and a plurality of source switches corresponding to a plurality of sound sources that belong to an arbitrarily selected rhythm bank, wherein sounds, which are created through the combinations of stored sound sources corresponding to the selection of one or more hank switches and one or more source switches, are output. The present invention can be immediately used without requiring a separate operation program to be executed when power is turned on. Furthermore, the present invention is a small-sized device that is convenient to carry, and thus it does not have spatial limitations. Furthermore, the present invention allows a player to creatively play music through the simple manipulation of a small number of switches.

### TECHNICAL FIELD

The present invention relates to a device for playing music and a method of outputting sounds using the same and, more particularly, to a device for playing music, which creates new sounds through combinations of various types of sound sources and outputs the created sounds, and a method of outputting sounds using the same.

### BACKGROUND ART

Due to the development of multimedia technology, persons' desires for sounds have further increased. In particular, the development of media technology not only causes people to merely listen to music, but also leads to the development of devices and programs for enabling the persons to actively and directly involve themselves in music and play the music, or to create a new music.

FIG. 1 shows a Dance Dance Revolution (DDR), which is an example of the prior art that has attracted sensational public attention recently. The DDR is a game device for stepping on keypads at precise times corresponding to sounds output according to a preset program. The DDR not only causes users to passively and merely listen to output music, but also causes the users to actively and directly involve themselves in the music and enjoy the music while stepping on the keypads in a predetermined sequence in time with the music.

Since then, game devices for playing various types of music had been marketed. However, most of the game devices merely play music according to a preset program. Although game devices for playing music to which the users' creativity is added have been invented, a very simple playable keyboard and devices similar thereto, which were manufactured for small children, have become mainstream devices. Furthermore, a synthesizer, which is used by experts who play music professionally and is a second example of the prior art, shown in FIG. 2, and a karaoke machine, similar thereto, have been marketed. However, when the above-described devices are used to create various sounds, the methods of use thereof are complicated, so that it is difficult for general persons to easily make use of them. Furthermore, the prices of the above-described devices are set considerably high. Furthermore, the above-described devices have a disadvantage in that they cannot be carried because they are large.

Besides, in the conventional technologies, sounds are chiefly output through speakers that are attached to the devices for playing music, so that high-priced speakers must be provided in the devices for playing music in order to listen to high-quality sounds, therefore there is a problem in that the price of the device for playing music is increased. Furthermore, the conventional technologies are devices for playing music that are chiefly played by a single person, so that there is a problem in that a plurality of players must be gathered at the same place in order to play music together.

### DISCLOSURE

### Technical Problem

Accordingly, the present invention has been made keeping in mind the above problems occurring in the prior art, and an object of the present invention is to provide a device and method for playing music using sounds based on a user's creative power, rather than using a simple programmed pattern that is followed by the user.

Another object of the present invention is to provide a device for playing music, which can be easily used by the user, unlike high-priced devices for outputting various types of sounds, which are difficult to operate and are inexpensive in price.

A further object of the present invention is to provide a device and method for playing music, which, when a plurality of players, rather than a single player, play their devices for playing music at spaced-apart locations, can mix and output orchestrated sounds.

### Technical Solution

In order to accomplish the above objects, the present invention provides a device for playing music, including a rhythm bank unit comprising a plurality of rhythm banks, each of which stores a plurality of sound sources as a group; a plurality of bank switches corresponding to the plurality of rhythm banks, and a plurality of source switches corresponding to a plurality of sound sources that belong to an arbitrarily selected rhythm bank; a bank extraction unit for extracting sound sources, which correspond to selected source switches, from a plurality of sound sources that belong to a rhythm bank selected by any of the bank switches, while the respective selected source switches are in selected states; and a sound output unit for outputting the sound sources, which are extracted from the bank extraction unit, as sounds; wherein sounds, which are created through the combinations of stored sound sources corresponding to the selection of one or more bank switches and one or more source switches, are output.

The plurality of sound sources may be different sound sources that are played for respective predetermined periods.

Furthermore, the device may further include hold switches each of which is used to maintain a selected bank switch and selected source switches in the selected states.

Furthermore, the sound output unit may include a speaker for outputting the created sounds. Furthermore, the sound output unit may include a transmitter for transmitting the created sounds to an external device. The transmitter imposes the created sounds on a Frequency Modulation (FM) radio frequency and transmits a sound signal.

It is preferred that the device be further include an external receiver for receiving the sound signal output from the transmitter, and the external receiver may include a reception unit for receiving a plurality of sound signals through a plurality of channels; a mixer unit for mixing the plurality of received sound signals; and an output unit for outputting a mixed signal.

Furthermore, the device may further include a storage unit for storing data about the created sounds and the sequence of the selection of the bank switch and the source switches that correspond to the sounds, and may also further include an interface unit connected with the external device and used to update the sound sources stored in each of the plurality of rhythm banks.

It is more preferable that the rhythm bank unit include five rhythm banks, each of the rhythm banks storing four sound sources, that is, a rhythm sound source, a sub-rhythm sound source, which is an auxiliary beat sound source, a chord and melody sound source, and a sound effect sound source, which are different each other.

In addition, the present invention provides a method of outputting sounds using a device for playing music, the device creating sounds though the combinations of stored sound sources, including the steps of selecting one bank switch from among a plurality of bank switches; selecting a rhythm bank corresponding to the selected bank switch; selecting one or more source switches; extracting sound sources, which correspond to the selected source switch, from sound sources that belong to the selected rhythm bank, while the respective selected source switches are in selected states; and outputting the extracted sound sources as sounds.

Furthermore, the method may further include, when a hold switch is selected, the step of repeatedly outputting the sound sources, which are extracted from the plurality of sound sources that belong to the rhythm bank selected by the bank switch and which correspond to the selected source switches

Furthermore, the method may further include the step of transmitting a sound signal, which is obtained through the conversion of the output sounds, to an external device through a transmitter provided in the device for playing music, and may further include the step of the external device receiving and outputting the sound signal output from the transmitter.

It is preferred that the method may further include the steps of a reception unit of an external receiver receiving the sound signal output from the transmitter; mixing different sound signals, which are received from respective transmitters of one or more different devices for playing music through a mixer unit provided in the external receiver, with the sound signal; and outputting a mixed sound signal though an output unit of the external receiver.

Furthermore, the method may further include the step of connecting with the external device and upgrading the sound sources stored in each of the plurality of rhythm banks.

Furthermore, the method may further include the step of storing the created sounds and the sequence of selection of the bank switch and the source switches, which correspond to the sounds, in a storage unit as data, and may further include the step of transmitting the data, which are stored in the storage unit, to the external device via an interface unit.

### ADVANTAGEOUS EFFECTS

The present invention can be immediately used without requiring a separate operation program to be executed when power is turned on. Furthermore, the present invention is a small-sized device that is convenient to carry, and thus it does not have spatial imitations and allows a player to creatively play music. Furthermore, the present invention can be simply manipulated using a small number of switches, and thus it can be easily used by a user.

### DESCRIPTION OF DRAWINGS

FIG. 1 is a diagram showing a DDR, which is an example of the prior art and is a game device for playing music in which a user participates;

FIG. 2 is a diagram showing a device for playing music, which is a second example of the prior art;

FIG. 3 is a block diagram showing the construction of a preferred embodiment of a device for playing music according to the present invention;

FIG. 4 is a diagram showing an embodiment for combining and outputting sound sources in the device for playing music according to the present invention;

FIG. 5 is a diagram showing the construction of a preferred embodiment of the rhythm bank unit of the device for playing music according to the present invention;

FIG. 6 is a block diagram showing the construction of a preferred embodiment of a receiver according to the present invention;

FIG. 7 is a block diagram showing the construction of an embodiment in which the interface of the device for playing music according to the present invention is used;

FIG. 8 is a flowchart schematically illustrating a method of outputting sounds using the device for playing music according to the present invention;

FIG. 9 is a flowchart schematically illustrating a method of outputting sounds using the receiver according to the present invention; and

FIG. 10 is a flowchart schematically illustrating a method of outputting sounds using the storage unit and the interface unit of the device for playing music according to the present invention.

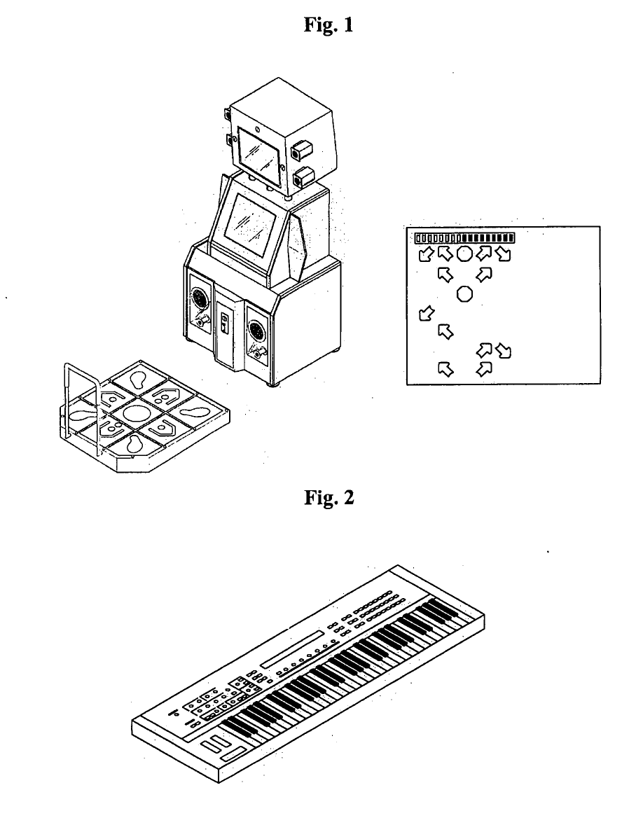

### BEST MODE

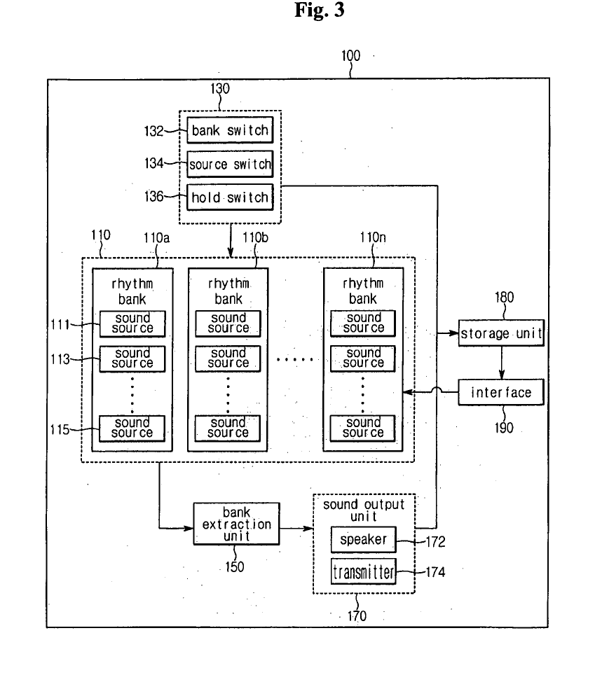

FIG. 3 is a block diagram schematically showing a device for playing music according to the present invention.

The device for playing music according to the present invention includes a rhythm bank unit 110, a switch unit 130, a bank extraction unit 150, and a sound output unit 170.

The rhythm bank unit 110 includes a plurality of rhythm banks 110a, 110b, . . . , 110n, each of which stores a plurality of sound sources 111, 113, . . . , 115 as a group. The sound sources 111, 113, . . . , 115 are different sound sources that are used to play music for respective predetermined periods. In this case, the sound sources may be various sound sources, such as beat sounds, rhythm sounds, melody sounds and sound effects.

The switch unit 130 includes a plurality of bank switches 132, a plurality of source switches 134, and a plurality of hold switches 136. The plurality of bank switches 132 corresponds to the plurality of rhythm banks 110a, 110b, . . . , 110n, and the plurality of source switches 134 corresponds to a plurality of sound sources 111, 113, . . . , 115 that belong to an arbitrarily selected rhythm bank.

Furthermore, each of the plurality of hold switches 136 is used to maintain a selected bank switch 132 and selected source switches 134 in selected states.

The bank extraction unit 150 extracts sound sources, which correspond to selected source switches 134, from a plurality of sound sources that belong to a rhythm bank selected by a bank switch 132 while the respective selected source switches are in selected states.

The sound output unit 170 outputs a combination of sound sources, which are extracted from the bank extraction unit 150, as sounds. In this case, the sounds are output through the speaker 172 or are transmitted to an external device through the transmitter 174.

### MODE FOR INVENTION

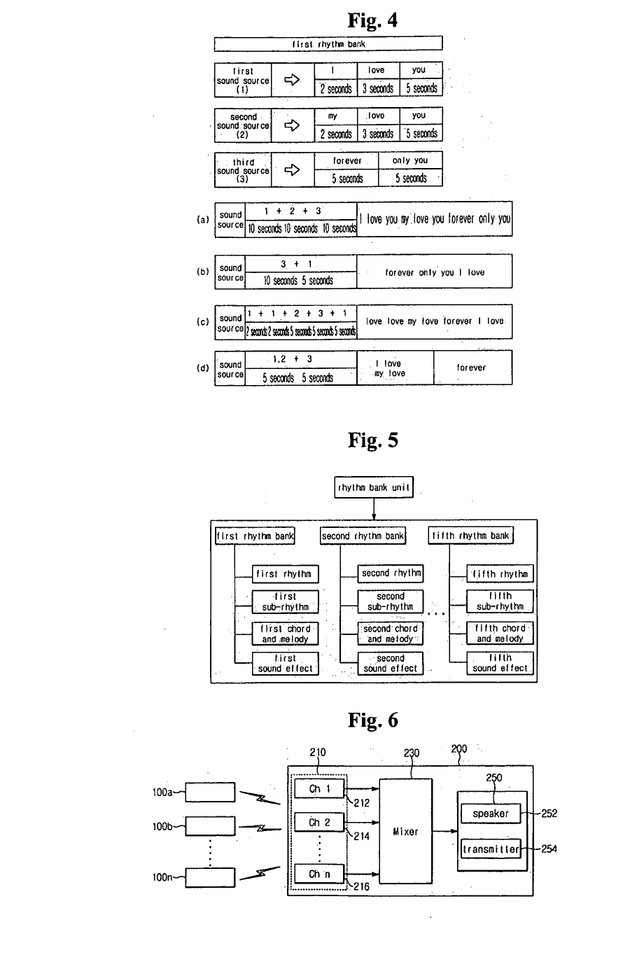

The present invention creates and outputs new sounds through combinations of sound sources selected from among preset sound sources by a user. FIG. 4 shows an embodiment in which the new sounds are created through combinations.

As shown in FIG. 4, under the assumption that first, second and third sound sources, which are three different lyrics, are already stored in a first rhythm bank, when a first bank switch corresponding to the first rhythm bank is selected and when the source switches are arbitrarily selected, sounds are created as shown in FIG. 4 (a), (b), (c) and (d). In greater detail, as shown in FIG. 4 (a), after the first bank switch is selected, when a first source switch corresponding to the first sound source is selected for 10 seconds, a second source switch corresponding to the second sound source is selected for 10 seconds, and then a third source switch corresponding to the third sound source is selected for 10 seconds, the sounds “I love you,” corresponding to the first sound source, are output for the first 10 seconds, the sounds “my love, you,” corresponding to the second sound source, is output for the next 10 seconds, and the sounds “forever only you,” corresponding to the third sound source, are output for the last 10 seconds. Furthermore, as shown in FIG. 4 (b), when the third source switch is selected for 10 seconds and then the first source switch is selected for 5 seconds, the sounds “forever only you,” corresponding to the third sound source 3, are output for the first 10 seconds, and the sounds “I love,” corresponding to the first sound source, are output for the next 5 seconds. Furthermore, as shown in FIG. 4 (c), when the first source switch is selected for 2 seconds, the first source switch is selected again for 2 seconds, the second source switch is selected for 5 seconds, and then the third source switch is selected for 5 seconds, the sounds “love, love, my love, forever I love you” are output. In addition, as shown in FIG. 4 (d), when the first source switch and the second source switch are simultaneously selected for 5 seconds and then the third source switch is selected for 5 seconds, the sounds “I love” and “my love” are simultaneously output, and then the sound “forever” is output.

In this case, when a hold switch is selected in a state in which the first bank switch and the first source switch are selected, the sound “I love you,” corresponding to the first sound source, are repeatedly output.

As described above, sounds that provides new feelings can be created and output through combinations of the plurality of stored sound sources.

FIG. 5 shows a preferred embodiment, in which sound sources are set for each of the rhythm banks of the device for playing music according to the present invention.

In the embodiment shown in FIG. 5, the rhythm bank unit has five rhythm banks. Each of the rhythm banks stores four sound sources as a group. The respective sound sources may be a rhythm sound source, a sub-rhythm sound source, a chord and melody sound source, and a sound effect sound source.

Each of the five rhythm banks stores the four sound sources as described above, so that the rhythm bank unit has a total of twenty different sound sources, and thus can create sounds by combining the sound sources.

Furthermore, the transmitter 174 provided in the sound output unit 170 transmits the created sounds to the external device. In this case, the transmitter 174 imposes the created sounds on a FM radio frequency and transmits a sound signal. The created sounds are transmitted in the form of the sound signal using the FM radio frequency, so that the user can transmit the created sounds in real time to persons located at remote locations, or to a plurality of persons, and the sounds can be listened to through existing audio systems, therefore it is not necessary to separately provide high-quality speakers.

In addition, an external receiver receives a plurality of sound signals transmitted from a plurality of devices for playing music according to the present invention, and mixing and outputting the received sound signals. FIG. 6 shows an embodiment in which the plurality of sound signals is mixed and output through the external receiver.

As shown in FIG. 6, the external receiver 200 includes a reception unit 210 having a plurality of channels 212, 214, . . . , 216. The plurality of sound signals, which is created by the plurality of devices 100a, 100b, . . . , 100n for playing music according to the present invention, are received through the respective channels 212, 214, . . . , 216, and the plurality of received sound signals are mixed by a mixer unit 230. A mixed signal generated by such mixing is output through an output unit 250. In this case, the mixed signal may be immediately output through a speaker 252 in sound form, and/or may be transmitted to the existing audio systems through a transmitter 254.

As described above, a completely different orchestrated sound that provides new feelings can be created through the mixing of the sound signals created by a plurality of players using the external receiver.

Furthermore, a storage unit 180 for storing the created sounds and the sequence of selection of the bank switch and the source switches as data, and an interface unit 190 for upgrading the sound sources 111, 113, . . . , 115, which are already stored, or outputting the data, which is stored in the storage unit 180, to the external device may be further included.

The sounds created as described above can be stored in the storage unit 180, and the sequence of selection of the bank switch and the source switches that correspond to the created sounds can also be stored in the storage unit 180 as data. In addition, the sounds stored in the storage unit 180 can be played back or transmitted to another external device. When the stored sounds are played back, the sequence of selection of the corresponding bank switch and source switches can be known.

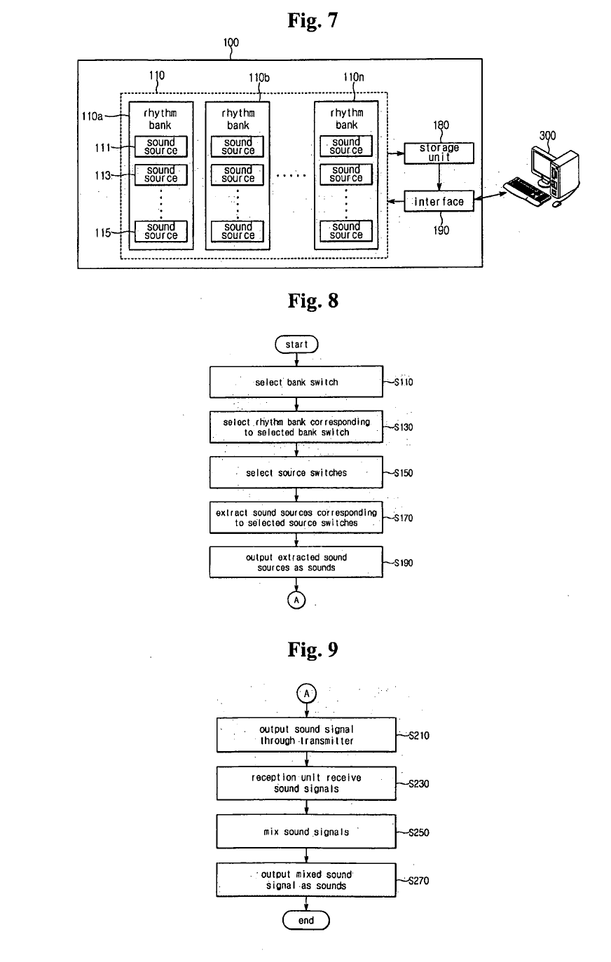

FIG. 7 shows an embodiment in which the interface of the device for playing music according to the present invention is used.

The user who uses the device for playing music according to the present invention can update the sound sources 111, 113, . . . , 115, which are stored in the rhythm bank unit 110, through the interface unit 190 of the device 100 for playing music by accessing a corresponding site via the external device, such as a Personal Computer (PC), and downloading various types of sound sources.

Furthermore, when the data about the sounds, which are stored in the storage unit 180, and the sequence of the selection of the bank switch and the source switches that correspond to the stored sounds is transmitted to the external device 300, such as a PC, via the interface unit 190, the sounds can be played back by the external device 300, such as a PC, and thus reproducibility, meaning that the created sounds are accurately played back, can be realized.

A method of outputting sounds using the device for playing music is described in detail below.

FIG. 8 is a flowchart schematically illustrating a method of outputting sounds using the device for playing music according to the present invention.

With reference to FIG. 8, when the user selects one bank switch from among the plurality of bank switches at step S5110, a rhythm bank corresponding to the bank switch is selected at step S130.

Thereafter, when the user selects one or more source switches from among the plurality of source switches at step S150, sound sources corresponding to the source switches are extracted while the respective source switches are in selected states, at step S170.

Sound sources corresponding to respective combinations depending on the selection of the bank switch and the source switches are mixed and output, or are output at time intervals, thus being created into sounds that provides new feelings.

The combinations of the sound sources extracted as described above are output as sounds through the output unit at step S190.

Furthermore, when a hold switch is selected, sound sources, corresponding to the selected source switches, among the plurality of sound sources that belong to the rhythm bank selected by the bank switch are repeatedly output.

By doing so, the sound sources, which are repeatedly output by the selection of the hold switch, are output and, at the same time, sound sources, corresponding to selected source switches, among sound sources that belong to a rhythm bank extracted through the selection of another bank switch, are output.

Furthermore, when the created sounds are output, the created sounds can be transmitted to the external device through the transmitter, provided in the device, at step S210. In this case, the created sounds are imposed on an FM radio frequency and are transmitted as a sound signal. Accordingly, the created sounds can be listened to using existing audio systems. In addition, the reception unit 210 of the receiver 200 according to the present invention can receive the sound signal at step S230. FIG. 9 is a flowchart schematically illustrating a method of outputting the created sounds using the receiver 200 according to the present invention. In this case, the channels 210 of the reception unit of the receiver 200 respectively receive a plurality of sound signals, which are transmitted from a plurality of different device for playing music according to the present invention, at step S230. The plurality of received sound signals are mixed by the mixer unit 230 of the receiver 200 at step S250, and a mixed sound signal is output through the output unit 250 of the receiver 200 as sounds.

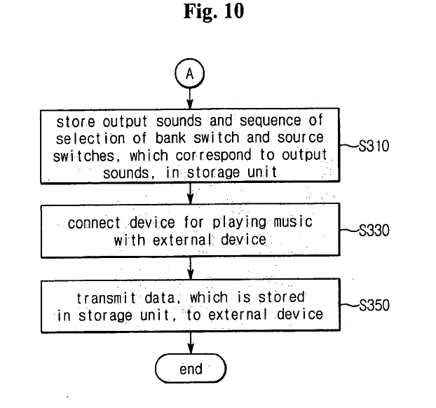

Furthermore, as shown in FIG. 10, sounds, which are created by the device 100 for playing music according to the present invention, and the sequence of selection of the bank switch and the source switches that correspond to the sounds are stored in the storage unit 180 at step S310, the device 100 for playing music is connected to the external device 300 through the interface 190 at step S330, and thus data about the sounds stored in the storage unit 180 and the sequence of selection of the bank switch and the source switches that correspond to the sounds can be transmitted to the external device 300 at step S350.

As described above, the data is transmitted to the external device 300 and, thus, the sound can be converted into various types of music files. Furthermore, in order to accurately realize the reproducibility of creation of the sounds, the sequence of selection of the bank switch and the source switches that correspond to the sounds can be viewed.

Using the above-described device for playing music according to the present invention and the method of outputting sounds using the same, persons can immediately play music without spatial limitations, and orchestrated music that provides new feelings can be listened to by mixing sounds created by individuals. In particular, the device for playing music according to the present invention is convenient for young people, such as break dancers, who enjoy hip hop and dancing, to carry, and can be enjoyed by a plurality of persons.

The device for playing music according to the present invention and the method of outputting sounds using the same can be modified and applied in various ways within the scope of the technical spirit of the present invention, but are not limited to the embodiments. Furthermore, the embodiments and the drawings are only for the purpose of illustrating the details of the invention but are not for the purpose of limiting the scope of the technical spirit of the invention. Persons having ordinary knowledge in the art to which the present invention pertains will appreciate that the present invention described above can be substituted, modified and changed in various ways within a range that does not depart from the technical spirit of the present invention, so that the scope of the present invention is not limited to the embodiments and the accompanying drawings but should be determined with reference to the following claims.

### INDUSTRIAL APPLICABILITY

As described above, in accordance with the present invention, a player can creatively play music by exerting his or her creativity. Furthermore, the present invention is a small-sized device that is convenient to carry, so that it does not have spatial limitations.

Furthermore, the created sounds are transmitted using an FM radio frequency, so that a plurality of persons can simultaneously listen to high-quality sounds through existing audio systems at spaced-apart locations without use of a separate sound output device.

Furthermore, unlike a high-priced device which requires complicated manipulation in order to output various sounds, the present invention requires only the manipulation of several switches, so that users can easily familiarize themselves with the present invention, and the manufacturing cost thereof is low, and the device for playing music can be immediately used without executing a separate operation program when the power is turned on.

In addition, when a plurality of players, rather than a single player, plays music with the device for playing music at spaced-apart locations, sounds created by the respective players are mixed and an orchestrated sound is output through the receiver and, at the same time, the players located at spaced-apart locations can listen to the orchestrated sound by setting the respective frequencies of existing audio systems to the same frequency, which coincides with the output frequency of the receiver.

1. A device for playing music, comprising:
a rhythm bank unit comprising a plurality of rhythm banks, each of which stores a plurality of sound sources as a group;
a plurality of bank switches corresponding to the plurality of rhythm banks, and a plurality of source switches corresponding to a plurality of sound sources that belong to an arbitrarily selected rhythm bank;
a bank extraction unit for extracting sound sources, which correspond to selected source switches, from a plurality of sound sources that belong to a rhythm bank selected by any of the bank switches, while the respective selected source switches are in selected states; and
a sound output unit for outputting the sound sources, which are extracted from the bank extraction unit, as sounds;
wherein sounds, which are created through combinations of stored sound sources corresponding to selection of one or more bank switches and one or more source switches, are output.

2. The device according to claim 1, wherein the plurality of sound sources are different sound sources that are played for respective predetermined periods.

3. The device according to claim 1, further comprising hold switches each of which is used to maintain a selected bank switch and selected source switches in the selected states.

4. The device according to claim 1, wherein the sound output unit comprises a speaker for outputting the created sounds.

5. The device according to claim 1, wherein the sound output unit comprises a transmitter for transmitting the created sounds to an external device.

6. The device according to claim 5, wherein the transmitter imposes the created sounds on a Frequency Modulation (FM) radio frequency and transmits a sound signal.

7. The device according to claim 5, further comprising an external receiver for receiving the sound signal output from the transmitter,
wherein the external receiver comprises:
a reception unit for receiving a plurality of sound signals through a plurality of channels;
a mixer unit for mixing the plurality of received sound signals; and
an output unit for outputting a mixed signal.

8. The device according to claim 1, further comprising a storage unit for storing data about the created sounds and sequence of selection of the bank switch and the source switches that correspond to the sounds.

9. The device according to claim 1, further comprising an interface unit connected with the external device and used to update the sound sources stored in each of the plurality of rhythm banks.

10. The device according to claim 1, wherein the rhythm bank unit comprises five rhythm banks, each of the rhythm banks storing four sound sources, that is, a rhythm sound source, a sub-rhythm sound source, which is an auxiliary beat sound source, a chord and melody, and a sound effect, which are different from each other.

11. A method of outputting sounds using a device for playing music, the device creating sounds though combinations of stored sound sources, comprising the steps of:
selecting one bank switch from among a plurality of bank switches;
selecting a rhythm bank corresponding to the selected bank switch;
selecting one or more source switches;
extracting sound sources, which correspond to the selected source switch, from sound sources that belong to the selected rhythm bank, while the respective selected source switches are in selected states; and
outputting the extracted sound sources as sounds.

12. The method according to claim 11, further comprising, when a hold switch is selected, the step of repeatedly outputting the sound sources, which are extracted from the plurality of sound sources that belong to the rhythm bank selected by the bank switch and which correspond to the selected source switches.

13. The method according to claim 11, further comprising the step of transmitting a sound signal, which is obtained through conversion of the output sounds, to an external device through a transmitter provided in the device for playing music.

14. The method according to claim 13, further comprising the step of the external device receiving and outputting the sound signal output from the transmitter.

15. The method according to claim 13, further comprising the steps of:
a reception unit of an external receiver receiving the sound signal output from the transmitter;
mixing different sound signals, which are received from respective transmitters of one or more different devices for playing music through a mixer unit provided in the external receiver, with the sound signal; and
outputting a mixed sound signal though an output unit of the external receiver.

16. The method according to claim 11, further comprising the step of connecting with the external device and upgrading the sound sources stored in each of the plurality of rhythm banks.

17. The method according to claim 11, further comprising the step of storing the created sounds and sequence of selection of the bank switch and the source switches, which correspond to the sounds, in a storage unit as data.

18. The method according to claim 17, further comprising the step of transmitting the data, which are stored in the storage unit, to the external device via an interface unit.
